(19) United States
(12) Patent Application Publication
(10) Pub. No.: US 2022/0311009 A1
(43) Pub. Date: Sep. 29, 2022

(54) ELECTRODE FOR LITHIUM ION SECONDARY BATTERY AND LITHIUM ION SECONDARY BATTERY

(71) Applicant: TDK CORPORATION, Tokyo (JP)

(72) Inventors: Kazuma AKIMOTO, Tokyo (JP); Masahiro SAEGUSA, Tokyo (JP)

(73) Assignee: TDK CORPORATION, Tokyo (JP)

(21) Appl. No.: 17/702,272

(22) Filed: Mar. 23, 2022

(30) Foreign Application Priority Data
Mar. 29, 2021 (JP) 2021-056297

(51) Int. Cl. H01M 4/66; H01M 10/0525; H01M 4/04; H01M 4/38; H01M 4/62; H01M 4/36

(52) U.S. Cl. CPC H01M 4/661; H01M 10/0525; H01M 4/0404; H01M 4/38; H01M 4/625; H01M 4/366; H01M 2004/021

(57) ABSTRACT

There is provided an electrode for a lithium ion secondary battery including: a metal foil; a conductive layer formed on at least a part of the metal foil; and an active material layer formed on at least a part of a surface on a side opposite to a side of the metal foil of surfaces of the conductive layer, in which the conductive layer contains conductive particles and an insulating resin, the active material layer contains a first active material layer and a second active material layer, the first active material layer and the second active material layer are laminated such that the first active material layer is closer to the conductive layer, and the second active material layer has a porosity larger than a porosity of the first active material layer.

### BACKGROUND OF THE INVENTION

### Field of the Invention

The present invention relates to an electrode for a lithium ion secondary battery and a lithium ion secondary battery.

Priority is claimed on Japanese Patent Application No. 2021-056297 filed on Mar. 29, 2021, the content of which is incorporated herein by reference.

### Description of Related Art

Lithium ion secondary batteries are lighter and have a higher energy density than nickel-cadmium batteries, nickel-hydride batteries, and the like, and are therefore widely applied as power sources for portable electronic devices. Lithium ion secondary batteries are also a promising candidate for power sources installed in hybrid vehicles or electric vehicles. With the recent miniaturization and increasing functionality of portable electronic devices, it is expected that lithium ion secondary batteries as a power source for these devices will have a higher energy density.

Current lithium ion secondary batteries have a high level of safety, but due to the high capacity and high output thereof, further improvement in terms of safety is required. For example, when a lithium ion secondary battery is overcharged, heat may be generated. In addition, heat may be generated due to the occurrence of an internal short circuit. Furthermore, since a lithium ion secondary battery contains a nonaqueous electrolyte containing an organic solvent, the organic solvent chemically decomposes with heat generation to generate gas, and problems such as an increase in the internal pressure of the battery may occur.

To solve such a problem, Patent Document 1 proposes a technology that provides a conductive layer on a surface of a current collector.

### PATENT DOCUMENTS

[Patent Document 1] International Publication No. 2017/014245

### SUMMARY OF THE INVENTION

However, the lithium ion secondary battery described in Patent Document 1 has a problem that the lithium ion secondary battery is insufficient for local sudden heat generation due to external impact. As a result of diligent research, the inventors have found that this problem can be solved by adopting a structure that dissipates heat generated at the short circuit part in addition to controlling the current generated at the short circuit part.

The present invention has been made in view of the problems, and an object thereof is to provide an electrode that suppresses the influence of heat generation due to external impact on a lithium ion secondary battery.

In order to achieve the above object, there is provided an electrode for a lithium ion secondary battery according to the present invention including: a metal foil; a conductive layer formed on at least a part of the metal foil; and an active material layer formed on at least a part of a surface on a side opposite to a side of the metal foil of surfaces of the conductive layer, in which the conductive layer contains conductive particles and an insulating resin, the active material layer contains a first active material layer and a second active material layer, the first active material layer and the second active material layer are laminated such that the first active material layer is closer to the conductive layer, and the second active material layer has a porosity larger than a porosity of the first active material layer.

In the electrode according to the present invention, when an impact is applied to a lithium ion secondary battery and an internal short circuit occurs, the insulating resin contained in the conductive layer flows into the short-circuited part and the short circuit resistance increases, and accordingly, the amount of current generated by the internal short circuit can be suppressed. Further, since the second active material layer of the electrode has a large porosity, the thermal conductivity is lowered. Therefore, the transfer of the heat generated at the internal short-circuited part is unlikely to occur between the positive and negative electrodes facing each other, and the transfer through the current collector having high heat dissipation is prioritized. Therefore, the temperature at the short-circuited part does not easily rise and it is possible to reduce the influence of heat generation.

Further, when the occupied area per unit area of the conductive particles is A and the occupied area per unit area of the insulating resin is B as the conductive layer is viewed from the thickness direction, 0.11≤A/B≤1.0 is preferable.

According to this, the resistance of the short-circuited part can be increased without reducing the output of the lithium ion secondary battery, and the effect of the present invention can be further enhanced.

Further, when the porosity of the second active material layer is C and the porosity of the first active material layer is D in the active material layer, 1.2≤C/D≤3.5 is preferable.

According to this, the heat generated at the internal short-circuited part can be efficiently dissipated through the current collector without reducing the output of the lithium ion secondary battery, and the effect of the present invention can be further enhanced.

According to the present invention, an electrode for a lithium ion secondary battery capable of reducing the influence of heat generation even when an impact is applied to the lithium ion secondary battery and an internal short circuit occurs, and a lithium ion secondary battery using the same can be obtained.

### BRIEF DESCRIPTION OF THE DRAWINGS

FIG. 1 is a schematic sectional view of a laminate of a lithium ion secondary battery according to an embodiment of the present invention.

### DETAILED DESCRIPTION OF THE INVENTION

Hereinafter, regarding the present invention, preferred embodiments of the present invention will be described. The present invention is not limited to the following embodiments.

<Lithium Ion Secondary Battery>

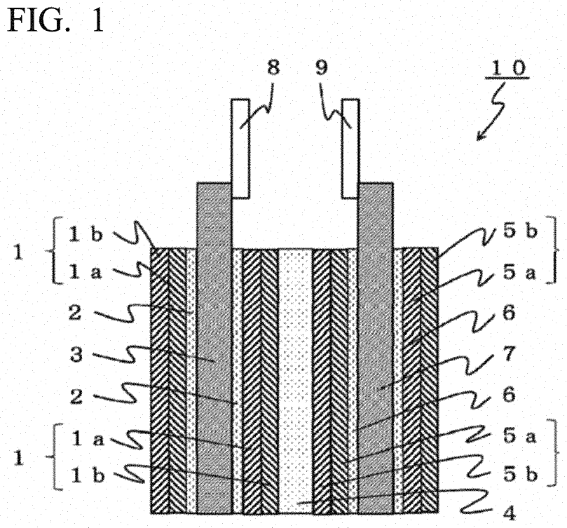

FIG. 1 illustrates a schematic sectional view of a laminate of a lithium ion secondary battery of the present embodiment.

A laminate 10 of the lithium ion secondary battery can be produced by producing a positive electrode composed of 1, 2, and 3, a negative electrode composed of 5, 6, and 7, and a separator 4 impregnated with an electrolyte, as illustrated in FIG. 1. Here, the positive electrode can be produced by forming the positive electrode active material layer 1 on the positive electrode current collector 3 or on the conductive layer 2 formed on the positive electrode current collector, and the negative electrode can be produced by forming the negative electrode active material layer 5 on the negative electrode current collector 7 or on the conductive layer 6 formed on the negative electrode current collector. However, in order to exert the effect of the present invention, it is necessary to form the conductive layer 2 between the positive electrode current collector 3 and the positive electrode active material layer 1, or to form the conductive layer 6 between the negative electrode current collector 7 and the negative electrode active material layer 5. In addition, it is necessary to form the positive electrode active material layer 1 by dividing the positive electrode active material layer 1 into two layers of positive electrode active material layers 1a and 1b, or to form the negative electrode active material layer 5 by dividing negative electrode active material layer 5 into two layers of negative electrode active material layers 5a and 5b. In the drawings, 8 and 9 indicate the positive and negative extraction electrodes, respectively.

<Electrode for Lithium Ion Secondary Battery Having Conductive Layer>

An electrode for a lithium ion secondary battery having a conductive layer according to the present embodiment includes a metal foil; a conductive layer formed on at least a part of the metal foil; and an active material layer formed on at least a part on a side opposite to the metal foil of the conductive layer, in which the conductive layer contains conductive particles and an insulating resin.

When an external impact is applied to a lithium ion secondary battery and an internal short circuit occurs, the resistance of the short-circuited part formed only by the active material layer and the current collector that configure the positive electrode and the negative electrode is low, and thus a large current can be generated. However, according to the present embodiment, since an insulating resin is contained in the conductive layer of the current collector, when an internal short circuit occurs, the insulating resin flows into the short-circuited part, the resistance at the short-circuited part increases, and the generation of a large current can be suppressed.

The metal foil may be a conductive plate material, for example, copper, nickel or an alloy thereof, and a thin metal plate (metal foil) such as those of stainless steel can be used for the negative electrode, and aluminum or an alloy thereof, and a thin metal plate (metal foil) such as those of stainless steel can be used for the positive electrode.

The ratio of the conductive particles contained in the conductive layer to the insulating resin can be obtained from the areas of both of the conductive particles and the insulating resin when the metal foil on which the conductive layer is formed is viewed from the thickness direction (that is, when viewed from the side opposite to the conductive layer in a plan view). When the area occupied by the conductive particles in the predetermined area is A and the area of the insulating resin is B, 0.11≤A/B≤1.0 is preferable. By being in this range, it is possible to keep the resistance at the short-circuited part at a sufficiently high value, and it is also possible to keep a better value in the rate characteristics when the lithium ion secondary battery is normally used. Since the conductive particles in the conductive layer serve as an electron conduction path between the current collector and the active material layer, when the proportion of the conductive particles is small, the rate characteristics may deteriorate.

It is desirable that the insulating resin has a resistance value capable of suppressing the generation of a large current when an internal short circuit occurs, and the resistance value is preferably 1.0×10⁸ [Ωcm] or more.

The conductive particles are not particularly limited as long as the conductive particles are materials having excellent conductivity, and examples thereof include carbon-based materials, fine metal powders such as those of copper, nickel, stainless steel, and iron, mixtures of a carbon materials and a fine metal powder, and conductive oxides such as ITO. However, carbon-based materials are particularly preferable from the viewpoint of compatibility with the resin materials. Examples of carbon-based materials include carbon black, graphene, carbon nanofibers, carbon nanotubes, carbon nanowalls, and graphite.

<Two Layers of Active Material Layer>

The active material layer according to the present embodiment includes a first active material layer and a second active material layer, the first active material layer and the second active material layer are laminated such that the first active material layer is closer to the conductive layer, and the second active material layer has a larger porosity than a porosity of the first active material layer.

The active material layer has a role of controlling the conduction of heat generated by the internal short circuit. Since the second active material layer has a large porosity, the thermal conductivity is low, the transfer of the heat generated at the internal short-circuited part is unlikely to occur between the positive and negative electrodes facing each other, and the transfer through a current collector having high heat dissipation is prioritized. Therefore, it is possible to further suppress the local temperature rise at the short-circuited part.

Regarding the ratio of the porosity of the second active material layer, when the porosity of the second active material layer is C and the porosity of the first active material layer is D, 1.2≤C/D≤3.5 is preferable. By being in this range, the decrease in the energy density of the lithium ion secondary battery is suppressed, the heat generated at the internal short-circuited part is preferentially dissipated from the current collector having high heat dissipation, and accordingly, it is possible to further suppress the local temperature rise at the short-circuited part.

<Measurement of Porosity of Active Material Layer>

The porosity of each layer in the first active material layer and the second active material layer was measured and calculated using a cross-sectional SEM. First, the thicknesses of each of the first active material layer and the second active material layer were measured by the cross-sectional SEM, and the density was calculated from the relationship between the basis weight and the thickness. Furthermore, the porosity was calculated based on the following Equation. Porosity=(1−density/true density calculated from materials that form each layer)×100

<Formation of Conductive Layer on Current Collector>

The conductive particles and the insulating resin are mixed and dispersed in a solvent such as water or N-methyl-2-pyrrolidone to produce a paste-like slurry. Next, one or both surfaces of the current collector such as an aluminum foil or a copper foil are coated with this slurry using a comma roll coater to form a coating film having a predetermined thickness, the slurry is introduced into the drying furnace, and the solvent is evaporated. When both surfaces of the current collector are coated, it is desirable that the thickness of the coating film that becomes the conductive layer is the same as that of both surfaces. Further, after evaporation of the solvent, pressure-forming may be performed by a roller press. The thickness of the conductive layer is preferably 1 [μm] or more and less than 10 [μm]. Accordingly, when an external impact is applied to the lithium ion secondary battery and an internal short circuit occurs, the conductive layer plays a role of increasing the resistance at the short-circuited part and, at the same time, the conductive layer does not reduce the output during normal use.

<Positive Electrode>

The positive electrode can be produced by forming the positive electrode active material layer 1 on the positive electrode current collector 3 or on the conductive layer 2 formed on the positive electrode current collector, as will be described later. When the positive electrode active material layer is separately formed being divided into the first active material layer and the second active material layer, the first active material layer is first formed on the conductive layer 2 formed on the positive electrode current collector, and the second active material layer is formed further on the first active material layer.

(Positive Electrode Current Collector)

The positive electrode current collector 3 may be any conductive plate material, and for example, a thin metal plate (metal foil) such as aluminum or an alloy thereof or stainless steel can be used.

(Positive Electrode Active Material Layer)

The positive electrode active material layer 1 is mainly formed of a positive electrode active material, a positive electrode binder, and a necessary amount of positive electrode conductive auxiliary agent.

(Positive Electrode Active Material)

The positive electrode active material is not particularly limited as long as it is possible to reversibly carry out the absorption and desorption of lithium ions, the elimination and insertion (intercalation) of lithium ions, or the doping and dedoping of lithium ions and counter anions (for example, PF₆⁻) of lithium ions, and a known electrode active material can be used. Examples of the composite metal oxide include the compounds of lithium cobalt oxide (LiCoO₂), lithium nickel oxide (LiNiO₂), and lithium manganese spinel (LiMn₂O₄), a composite metal oxide expressed by the general formula: LiNiₓCo_{y}Mn_{z}MaO₂ (x+y+z+a=1, 0≤x<1, 0≤y<1, 0≤z<1, 0≤a<1, where M is one or more kinds of elements selected from Al, Mg, Nb, Ti, Cu, Zn, and Cr), lithium vanadium compound (LiV₂O₅), olivine-type LiMPO₄ (where M is one or more kinds of elements selected from Co, Ni, Mn, Fe, Mg, Nb, Ti, Al, and Zr, or VO), and other composite metal oxides such as lithium titanate (Li₄Ti₅O₁₂) and LiNiₓCo_{y}Al_{z}O₂ (0.9<x+y+z<1.1).

(Positive Electrode Binder)

The positive electrode binder binds the positive electrode active material to each other and binds the positive electrode active material to the current collector. The binder may be any binder as long as the binding is possible as described above, and for example, a fluororesin such as polyvinylidene fluoride (PVDF) or polytetrafluoroethylene (PTFE) can be used. Furthermore, in addition to this, examples of the binder include cellulose, styrene/butadiene rubber, ethylene/propylene rubber, polyimide resin, polyamide-imide resin, and acrylic resin. Further, as the binder, an electron-conducting conductive polymer or an ion-conducting conductive polymer may be used. Examples of the electron-conducting conductive polymer include polyacetylene. In this case, since the binder also exerts the function of the conductive auxiliary agent particles, the conductive auxiliary agent may not be added. As the ion-conducting conductive polymer, for example, one having conductivity of ions such as lithium ion can be used, and examples thereof include a composite of a monomer of a polymer compound (polyether-based polymer compounds such as polyethylene oxide and polypropylene oxide, polyphosphazene, and the like), and a lithium salt such as LiClO₄, LiBF₄, or LiPF₆ or alkali metal salts mainly composed of lithium. Examples of the polymerization initiator used for the complexation include a photopolymerization initiator or a thermal polymerization initiator compatible with the above-mentioned monomers.

(Positive Electrode Conductive Auxiliary Agent)

The positive electrode conductive auxiliary agent is also not particularly limited as long as the conductivity of the positive electrode active material layer is improved, and a known conductive auxiliary agent can be used. Examples thereof include carbon-based materials such as graphite and carbon black; fine metal powders such as those of copper, nickel, stainless steel, and iron; mixtures of a carbon materials and a fine metal powder; and conductive oxides such as ITO.

<Negative Electrode>

The negative electrode can be produced by forming the negative electrode active material layer 5 on the negative electrode current collector 7 or on the conductive layer 6 formed on the negative electrode current collector, as will be described later. When the negative electrode active material layer is separately formed being divided into the first active material layer and the second active material layer, the first active material layer is first formed on the conductive layer 6 formed on the negative electrode current collector, and the second active material layer is formed further on the first active material layer.

(Negative Electrode Current Collector)

The negative electrode current collector 7 may be a conductive plate material, and for example, a thin metal plate (metal foil) such as those of copper, nickel or an alloy thereof, or stainless steel can be used.

(Negative Electrode Active Material Layer)

The negative electrode active material layer 5 is mainly formed of a negative electrode active material, a negative electrode binder, and a necessary amount of negative electrode conductive auxiliary agent.

(Negative Electrode Active Material)

Examples of the negative electrode active material include graphite, silicon oxide (SiOₓ), and metal silicon (Si).

(Negative Electrode Binder)

The negative electrode binder is not particularly limited, and the same binder as the positive electrode binder described above can be used.

The content of the binder in the negative electrode active material layer 5 is also not particularly limited, but is preferably 1 to 20 parts by mass of the entire negative electrode active material layer.

(Negative Electrode Conductive Auxiliary Agent)

The negative electrode conductive auxiliary agent is not particularly limited, and the same conductive auxiliary agent as the positive electrode conductive auxiliary agent described above can be used.

<Electrolyte>

Examples of the electrolytes include LiPF₆, LiClO₄, LiBF₄, LiAsF₆, LiCF₃SO₃, LiCF₃, CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, and LiBOB. One type of these salts may be used alone, or two or more types may be used in combination.

Although the preferred embodiment according to the present invention has been described above, the present invention is not limited to the above-described embodiment.

### EXAMPLE

Hereinafter, the present invention will be described in more detail based on Examples and Comparative Examples, but the present invention is not limited to the following Examples.

### Example 1

(Formation of Conductive Layer on Current Collector)

In Example 1, 1.1 parts by mass of acetylene black as conductive particles, 1.0 part by mass of PVdF as an insulating resin, and N-methylpyrrolidone as a solvent were mixed to prepare a slurry for forming a conductive layer. Both surfaces of an aluminum foil having a thickness of 12 [μm] are coated with this slurry and dried at 100 [° C.] to obtain a positive electrode current collector in which a conductive layer having a thickness of 0.90 [μm] is formed.

(Production of Positive Electrode)

A slurry for forming an active material layer was prepared by mixing 96 parts by mass of LiCoO₂ as a positive electrode active material, 2 parts by mass of acetylene black as a conductive auxiliary agent, 2 parts by mass of PVdF as a binder, and N-methylpyrrolidone as a solvent. Both surfaces of the positive electrode current collector on which the conductive layer obtained above was formed were coated with this slurry, and dried at 100 [° C.] to obtain the first active material layer. Furthermore, both surfaces of the first active material layer obtained above were coated with the slurry, and dried at 100 [° C.] to obtain the second active material layer. Then, by performing pressure-forming by a roller press, a positive electrode having a positive electrode active material layer was obtained.

(Production of Negative Electrode)

A slurry for forming an active material layer was prepared by mixing 83 parts by mass of Si as a negative electrode active material, 2 parts by mass of acetylene black as a conductive auxiliary agent, 15 parts by mass of polyamidimide as a binder, and N-methylpyrrolidone as a solvent. Both surfaces of a copper foil having a thickness of 10 [μm] were coated with this slurry, and dried at 100 [° C.]. Then, by pressure-forming by a roller press, and performing heat treatment in vacuum at 350 [° C.] for 3 hours, a negative electrode having a negative electrode active material layer was obtained.

(Production of Lithium Ion Secondary Battery for Evaluation)

The positive electrode and the negative electrode produced above were put into an aluminum laminate pack with a separator made of a polyethylene microporous film sandwiched therebetween, and injecting 1 M of LiPF₆ solution (solvent: ethylene carbonate/diethyl carbonate=3/7 (volume ratio)) as an electrolytic solution into this aluminum laminate pack. Then, vacuum sealing was performed to produce a lithium ion secondary battery for evaluation.

<Measurement of Rate Characteristics>

For the lithium ion secondary battery for evaluation produced in Example 1, the voltage range was changed from 2.8 [V] to 4.2 [V] in a thermostatic chamber at a temperature of 25° C. using a secondary battery charge/discharge test device (manufactured by HOKUTO DENKO CORPORATION), one cycle of charging and discharge was performed with a current value of 0.05 C, and it was confirmed that the capacity was normal. Similarly, after charging at a current value of 0.05 C, discharging was performed at a current value of 0.2 C or 2 C, the discharge capacity at each rate was obtained, and the rate characteristics (100×2 C discharge capacity/0.2 C discharge capacity) were determined. When the resistance value of the conductive layer formed on the positive electrode current collector is low, the movement of electrons at a high rate is not hindered, and thus a high retention rate is exhibited.

<Measurement of Battery Surface Temperature>

For the lithium ion secondary battery for evaluation produced in Example 1, charging was performed to 4.2 [V] in a thermostatic chamber at a temperature of 25 [° C.] using a secondary battery charge/discharge test device (manufactured by HOKUTO DENKO CORPORATION). Then, a nail penetration test was performed. In the nail penetration test, the lithium ion secondary battery for evaluation was fixed onto a phenol resin plate having a hole with a diameter of 10 [nm] in a thermostatic chamber at a temperature of 25 [° C.], and an iron nail having a diameter of 3 [mm] and a length of 65 [mm] was pierced perpendicularly to the lithium ion secondary battery for evaluation at a speed of 10 [mm/s], penetrated by 10 [mm] from the battery, and held for 3 minutes, and then pulled out. The battery surface temperature was measured 30 seconds after the nail was pierced into the battery.

### Examples 2 to 11

Lithium ion secondary batteries of Examples 2 to 11 were obtained in the same manner as in Example 1 except that the ratio of the conductive particles contained in the conductive layer to the insulating resin, the porosity of the second active material layer in the active material layer, and the porosity of the first active material layer were changed to those shown in Table 1. Further, using the obtained lithium ion secondary battery, the rate characteristics and the battery surface temperature of Examples 2 to 11 were measured in the same manner as in Example 1.

The evaluation results of Examples 1 to 11 are shown in Table 1. A conductive layer was formed on the positive electrode current collector as in Examples 1 to 11, the porosity of the second active material layer in the active material layer was made larger than the porosity of the first active material layer, and accordingly, a low battery surface temperature was shown. Further, it was confirmed that, by setting the C/D, which is the ratio of the porosity of the second active material layer to the porosity of the first active material layer, to a suitable range, the battery surface temperature tends to be even lower. Further, it was confirmed that, by setting A/B, which is the ratio of the conductive particles contained in the conductive layer to the insulating resin, to a suitable range, the battery surface temperature tends to be low while maintaining high rate characteristics.

### Comparative Examples 1 to 3

Lithium ion secondary batteries of Examples 1 to 3 were obtained in the same manner as in Example 1 except that the presence or absence of the conductive layer, the ratio of the conductive particles contained in the conductive layer to the insulating resin, the porosity of the second active material layer in the active material layer, and the porosity of the first active material layer were changed to those shown in Table 1. Further, using the obtained lithium ion secondary battery, the rate characteristics and the battery surface temperature of Comparative Examples 1 to 3 were measured in the same manner as in Example 1.

Table 1 shows the evaluation results of Comparative Examples 1 to 3. In Comparative Example 1, the conductive layer did not exist, and a relatively high battery surface temperature was shown. Further, in Comparative Example 2, although the conductive layer had A/B in a suitable range, the porosity of the second active material layer was smaller than the porosity of the first active material layer, and thus a relatively high battery surface temperature was shown. Further, in Comparative Example 3, the conductive layer did not exist, and in addition, the porosity of the second active material layer was smaller than the porosity of the first active material layer, and thus the highest battery surface temperature was shown.

TABLE 1

| | | | | | Thickness | | |
|---|---|---|---|---|---|---|---|
| | | | | | of | | Battery |
| | | | | | conductive | Rate | surface |
| | Conductive | Insulating | | | layer | characteristics | temperature |
| | particles | resin | A/B | C/D | [μm] | [%] | [° C.] |
| Example 1 | Carbon black | PVdF | 1.10 | 1.10 | 0.90 | 98 | 45 |
| Example 2 | Carbon black | PVdF | 1.10 | 1.10 | 5.00 | 91 | 44 |
| Example 3 | Carbon black | PVdF | 1.10 | 1.10 | 11.00 | 85 | 40 |
| Example 4 | Carbon black | PVdF | 1.10 | 1.50 | 5.00 | 98 | 41 |
| Example 5 | Carbon black | PVdF | 1.10 | 3.60 | 5.00 | 90 | 45 |
| Example 6 | Carbon black | PVdF | 0.50 | 1.10 | 5.00 | 90 | 45 |
| Example 7 | Carbon black | PVdF | 0.50 | 1.50 | 5.00 | 90 | 36 |
| Example 8 | Carbon black | PVdF | 0.50 | 3.60 | 5.00 | 90 | 44 |
| Example 9 | Carbon black | PVdF | 0.10 | 1.10 | 5.00 | 85 | 41 |
| Example 10 | Carbon black | PVdF | 0.10 | 1.50 | 5.00 | 86 | 29 |
| Example 11 | Carbon black | PVdF | 0.10 | 3.60 | 5.00 | 86 | 41 |
| Comparative | — | — | — | 1.50 | — | 85 | 240 |
| Example 1 | | | | | | | |
| Comparative | Carbon black | PVdF | 0.50 | 0.90 | 5.00 | 90 | 244 |
| Example 2 | | | | | | | |
| Comparative | — | — | — | 0.90 | — | 86 | 260 |
| Example 3 | | | | | | | |

It is possible to provide a lithium ion secondary battery in which the influence of heat generation is suppressed by providing a conductive layer on the current collector and forming an active material layer into two layers of a second active material layer having a large porosity and a first active material layer having a small porosity.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Positive electrode active material
1a Positive electrode first active material layer
1b Positive electrode second active material layer
2 Conductive layer provided on positive electrode
3 Positive electrode current collector
4 Separator
5 Negative electrode active material
5a Negative electrode first active material layer
5b Negative electrode second active material layer
6 Conductive layer provided on negative electrode
7 Negative electrode current collector
8, 9 Lead
10 Laminate of lithium ion secondary battery

What is claimed is:

1. An electrode for a lithium ion secondary battery comprising:
a metal foil;
a conductive layer formed on at least a part of the metal foil; and
an active material layer formed on at least a part of a surface on a side opposite to a side of the metal foil of surfaces of the conductive layer, wherein
the conductive layer contains conductive particles and an insulating resin,
the active material layer contains a first active material layer and a second active material layer,
the first active material layer and the second active material layer are laminated such that the first active material layer is closer to the conductive layer, and
the second active material layer has a porosity larger than a porosity of the first active material layer.

2. The electrode for a lithium ion secondary battery according to claim 1, wherein
when an occupied area per unit area of the conductive particles as the conductive layer is viewed from a thickness direction is A, and an occupied area per unit area of the insulating resin is B, 0.11≤A/B≤1.0 is satisfied.

3. The electrode for a lithium ion secondary battery according to claim 1, wherein
when the porosity of the second active material layer is C and the porosity of the first active material layer is D in the active material layer, 1.2≤C/D≤3.5 is satisfied.

4. A lithium ion secondary battery comprising:
the electrode for a lithium ion secondary battery according to claim 1.
